(19) United States
(12) Patent Application Publication
(10) Pub. No.: US 2025/0142530 A1
(43) Pub. Date: May 1, 2025

(54) ENHANCEMENT TO DSCP BASED PAGING POLICY DIFFERENTIATION

(71) Applicant: Telefonaktiebolaget LM Ericsson (publ), Stockholm (SE)

(72) Inventors: Zhansheng WEI, Shanghai (CN); Jinyin ZHU, Shanghai (CN); Yingjiao HE, Shanghai (CN); Yong YANG, Kållered (SE); Lin SHANG, Shanghai (CN)

(73) Assignee: Telefonaktiebolaget LM Ericsson (publ), Stockholm (SE)

(21) Appl. No.: 18/836,424

(22) PCT Filed: Jan. 31, 2023
(86) PCT No.: PCT/EP2023/052257

§ 371 Date: Aug. 7, 2024

(30) Foreign Application Priority Data
Feb. 9, 2022 (WO) PCT/CN2022/075663

(51) Int. Cl. H04W 68/02; H04W 28/02; H04W 76/10

(52) U.S. Cl. CPC H04W 68/02; H04W 28/0268; H04W 76/10

(57) ABSTRACT

A method for facilitating paging policy differentiation, performed by a Session Management Function (SMF) is provided. The method includes determining that a paging policy differentiation feature is supported by a User Plane Function (UPF) (325). The method includes sending, toward the UPF (325), a message instructing the UPF (325) to insert a Paging Policy Indicator (PPI) value (110) into downlink packets based on a Differentiated Services Code Point (DSCP) value (106). The message includes DSCP-to-PPI control information.

### TECHNICAL FIELD

This disclosure relates to enhancing DSCP based paging policy differentiation.

### BACKGROUND

Paging policy differentiation (PPD) is a feature that allows the Access and Mobility Management Function (AMF), based on operator configuration, to apply different paging strategies for different traffic or service types provided within the same Protocol Data Unit (PDU) Session. When the 5G System (5GS) supports the PPD feature, the Differentiated Services Code Point (DSCP) value (Type of Service (ToS) in IPv4/Traffic Class (TC) in IPv6) is set by the application to indicate to the 5GS which Paging Policy should be applied for a certain Internet Protocol (IP) packet.

For a UE in Radio Resource Control (RRC) Inactive state the Next Generation Radio Access Network (NG-RAN) may enforce specific paging policies in the case of NG-RAN paging, based on 5G Quality of Service (QoS) Identifiers (5QI), Allocation and Retention Priority (ARP), and Paging Policy Indicator (PPI) associated with an incoming downlink (DL) PDU. To enable this, the Session Management Function (SMF) instructs the User Plane Function (UPF) to detect the DSCP in the ToS (IPv4)/TC (IPv6) value in the IP header of the DL PDU (by using a DL Packet Detection Rule (PDR) with the DSCP for this traffic) and to transfer the corresponding PPI in the Core Network (CN) tunnel header (by using a QoS Enforcement Rule (QER) with the PPI value). The NG-RAN can then utilize the PPI received in the CN tunnel header of an incoming DL PDU in order to apply the corresponding paging policy for the case the UE needs to be paged when in RRC Inactive state. It shall be possible for the operator to configure the SMF in such a way that the Paging Policy Differentiation feature only applies to certain Home Public Land Mobile Networks (HPLMNs), Data Network Names, (DNNs) and 5QIs.

In the case of Home-Routed roaming, the Visiting SMF (V-SMF) is responsible for controlling the UPF setting of the PPI. In the case of a PDU Session with an Intermediate SMF (I-SMF), the I-SMF is responsible for controlling the UPF setting of the PPI.

As shown in FIG. 1, a UPF 102 may have an incoming DL PDU 104, which includes a General Packet Radio System (GPRS) Tunneling Protocol User Plane (GTP-U) layer 104a and a GTP-U payload 104b. Within the IP header of the GTP-U payload 104b is the user data DSCP value 106. This value 106 may be mapped to the PPI 110 within the DL PDU Session Information 108.

3rd Generation Partnership Project (3GPP) Technical Specification (TS) 23.501 V17.3.0 (2021-12) in chapter 5.4.3.2 Paging Policy Differentiation and TS 38.415 V16.6.0 (2021-12) in chapter Transfer of DL PDU Session Information provide more information.

### SUMMARY

Per the existing Packet Forwarding Control Protocol (PFCP) protocol, the SMF shall provision the PPI in a QER, so the UPF shall set the PPI for DL traffic matching the PDR with which the QER is associated. The PDRs will be provisioned to detect DSCP code(s), i.e. the SMF will be configured with a DSCP code(s) to PPI mapping table. This may work when the SMF knows which DSCP code will be set by the application server, for example, it may work for an IN-UPF where service level detection is not required. It has a problem, for example, in the case where the PDU Session Anchor (PSA) UPF is directly connected to the NG-RAN, since the SMF does not know, for a specific Service Data Flow (SDF) which DSCP code will be set by the application server. Therefore, to comply with the standard, it seems that the SMF must blindly provision all possible DSCPs for the same SDF, particularly in the cases where: (1) the Application ID is used to match the incoming packet; (2) a List of SDF Filters with different DSCP values (ToS/TC) are associated the same PDR; or (3) the DSCP value of the SDF is unknown by the SMF (e.g., not defined as a match condition of the DL packet by the Policy Control Function (PCF)). Therefore, to support PPI functionality, the SMF shall create different DL PDRs corresponding to all possible DSCP values to match the incoming packets. But this is unrealistic considering the number of DSCP value as shown below: {af11 | af12 | af13 | af21 | af22 | af23 | af31 | af32 | af33 | af41 | af42 | af43 | be | cs1 | cs2 | cs3 | cs4 | cs5 | cs6 | cs7 | ef}.

Under the existing PFCP protocol, therefore, the SMF needs to provision extra SDF filters to address all possible DSCP values for each of SDF. This can mean that up to 64 SDF filters per SDF (corresponding to 64 possible DSCP values) may have to be provisioned. The SMF needs to provision those extra PDRs/QERs for each SDF. This can mean that up to 8 PDRs/QERs per SDF (corresponding to 8 possible PPI values) may have to be provisioned to address the SA2 requirement to enable DSCP(s) mapped to PPI(s).

FIG. 2 illustrates the connection between the PDR and QER (indicating the PPI). As shown in FIG. 2, the DSCP value (ToS/TC) is defined in the SDF filter as a match condition of the incoming packets (such as DL PDR 200), and PPI in a QER is used to indicate the corresponding PPI in the CN tunnel header for the incoming packets.

Another problem is that since the PPI value is used by NG-RAN to apply the corresponding paging policy for the case the UE needs to be paged when in RRC Inactive state, w when the UE is in RRC connected state, the PPI value is not needed. However, the SMF/UPF does not know the RRC states and will set the PPI value for all DL pack in DL PDU, which is too much cost for performance considering the PPI value mapping from DSCP in the ToS (IPv4)/TC (IPv6) value in the IP header of each DL PDU.

If the PPD feature is enabled for certain HPLMNs, DNNs, and/or 5QIs in the SMF, the SMF instructs the UPF to detect the DSCP in the ToS (IPv4)/TC (IPv6) value in the IP header of the DL PDU and transfer the corresponding PPI in the CN tunnel header. The instruction can be per PFCP session or 5QI or service. The UPF marks the PPI mapping from the DSCP of the incoming packet. The DSCP to PPI mapping can be configured in UPF or can be instructed by the SMF. The SMF may instruct the UPF to only transfer the corresponding PPI in the first few DL packets (for example, the first 10 packets) after a period exceeding a threshold value when there is no uplink (UL) and no DL payload, during which it can be assumed that the UE has entered the RRC_Inactive state.

Advantages of embodiments disclosed herein include that such embodiments allow an operator to fully support PPD functionality as defined by TS23.501 V17.3.0 (2021-12).

According to some embodiments, there is provided a method for facilitating paging policy differentiation, performed by a Session Management Function (SMF). The method includes determining that a paging policy differentiation feature is supported by a User Plane Function (UPF) and that the paging policy differentiation feature is applicable to a Protocol Data Unit (PDU) Session. The method includes sending, toward the UPF, a message instructing the UPF to insert a Paging Policy Indicator (PPI) value into outgoing packets based on a Differentiated Services Code Point (DSCP) value. The message includes DSCP-to-PPI control information.

In some embodiments, the message instructs the UPF to insert the PPI value into a General Packet Radio System (GPRS) Tunneling Protocol User Plane (GTP-U) layer extension header of GTP-U packets encapsulating payload packets and the DSCP value is in the IP header of the payload packets. In some embodiments, the DSCP-to-PPI control information further includes one or more DSCP-to-PPI mapping information, one or more Quality of Service (QoS) flow identifiers (QFIs), and a timer. In some embodiments, the timer is configured to cause the UPF to insert corresponding PPI values into a fixed number of outgoing packets only after a period determined by the timer when there is no incoming or outgoing packets. In some embodiments, the one or more QFIs indicate to the UPF to which Qos Flows payload packets pertain that are eligible for inserting PPI based on the DSCP-to-PPI mapping information. In some embodiments, the DSCP-to-PPI mapping information includes one of (1) an index to enable the UPF to select a DSCP-to-PPI mapping table preconfigured in the UPF, and (2) a table mapping the DSCP of payload packets to a corresponding PPI. In some embodiments, the message is a Packet Forwarding Control Protocol (PFCP) session message. In some embodiments, the PFCP message is one of a PFCP Session Establishment Request or a PFCP Session Modification Request.

According to another embodiment, a method for facilitating paging policy differentiation, performed by a User Plane Function (UPF), is provided. The method includes receiving, from a Session Management Function (SMF), a message containing DSCP-to-PPI control information request the UPF to insert a Paging Policy Indicator (PPI) value into outgoing packets. The method includes retrieving a Differentiated Services Code Point (DSCP) value in the Internet Protocol (IP) header of an incoming payload packet. The method includes determining a PPI value for an outgoing packet based on the DSCP value and the DSCP-to-PPI mapping information. The method includes inserting the PPI value into the outgoing packet.

In another aspect there is provided a computer program comprising instructions which when executed by processing circuitry causes the processing circuitry to perform any of the methods disclosed herein.

In another aspect there is provided a carrier containing the computer program disclosed herein. The carrier may be one of an electronic signal, an optical signal, a radio signal, and a computer readable storage medium.

In another aspect there is provided an apparatus being configured to perform any of the methods disclosed herein.

### BRIEF DESCRIPTION OF THE DRAWINGS

FIG. 1 depicts a relationship between a DSCP value and PPI value in a DL PDU.

FIG. 2 depicts a DL PDR.

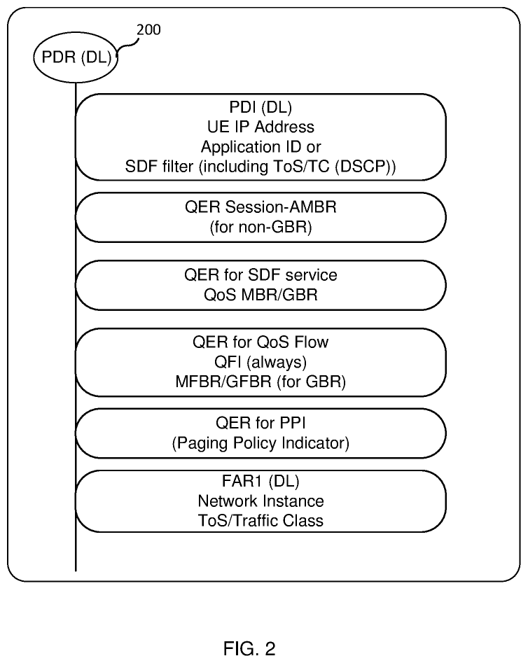

FIG. 3 depicts a reference architecture of a 5G communications system.

FIG. 4 is a message flow diagram illustrating a message flow according to some embodiments.

FIG. 5 is a message flow diagram illustrating a message flow according to some embodiments.

FIG. 6 is a message flow diagram illustrating a message flow according to some embodiments.

FIG. 7 is a flowchart illustrating a process according to some embodiments.

FIG. 8 is a flowchart illustrating a process according to some embodiments.

FIG. 9 is a block diagram of a physical machine according to some embodiments.

### DETAILED DESCRIPTION

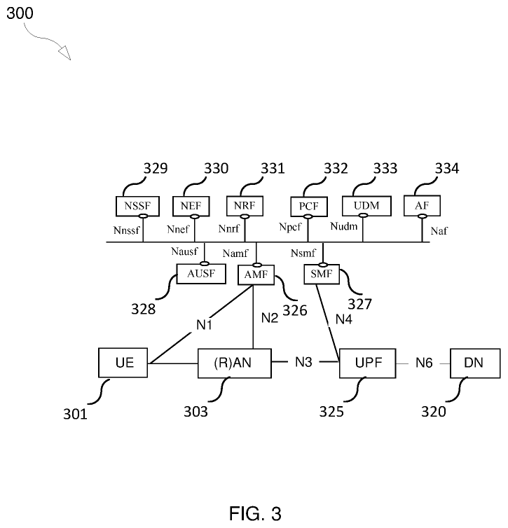

FIG. 3 depicts a reference architecture of a communications system 300 according to one embodiment. In the example shown, system 300 is a 5G system. More specifically, FIG. 3 depicts a UE 301 that is connected to an access network (AN) 303, which may be a radio access network (RAN). AN 303 is connected to an Access and Mobility Management Function (AMF) 326 via a N2 reference point and the AN is also connected to a User plane Function (UPF) 325 via an N3 reference point. UPF 325 is adapted to be connected to a Session Management Function (SMF) 327 via a N4 reference point and is adapted to be connected to a data network (DN) 320 via a N6 reference point. The DN may be, for example, operator services, Internet access or 3rd party services. UE 301 is also connected to AMF 326 via a N1 reference point. As further shown in FIG. 3, system 300 further includes the following additional network functions: an Authentication Server Function (AUSF) 328, a Network Slice Selection Function (NSSF) 329, a Network Exposure Function (NEF) 330, a NRF 331, a Policy Control function (PCF) 332, a Unified Data Management (UDM) 333, and an Application Function (AF) 334. Each of the network functions 326-334 exhibits a service based interface. For example, the service based interface exhibited by the NSSF 329 is referred to as “Nnssf”. Similarly, the service based interface exhibited by AMF 326 is referred to as “Namf”.

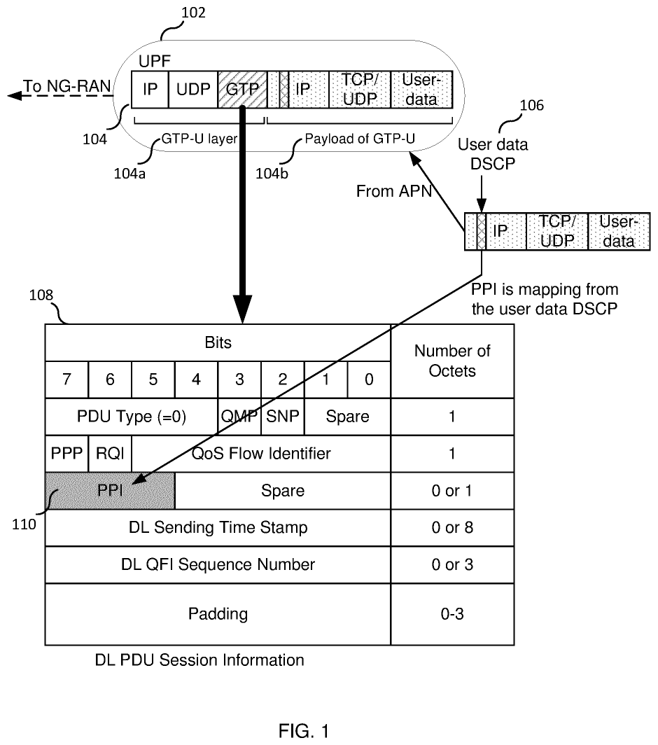

UE 301 may be any communication device, mobile or stationary, enabled to communicate over a wireless channel (e.g., radio channel) with an access point of an AN (e.g., a base station). For instance, UE 301 may be a mobile phone, smart phone, sensor, meter, vehicle, appliance (household, medical, etc.), media player, camera, Machine to Machine (M2M) device or any type of consumer electronic devices, for instance but not limited to television, radio, lighting arrangements, tablet computer, laptop or Personal Computer (PC). UE 301 may be portable, pocket storable, hand held, computer comprised, or vehicle mounted, and may be enabled to communicate voice and/or data, via the radio access network, with another entity, such as another UE or a server. The AN 303 may comprise an access point (not shown in FIG. 1) such as a NodeB, an eNodeB, a gNB, a Wi-Fi access point, or any other access point capable to communicate over a radio carrier with the UE 301. The abbreviations AN and RAN may be used interchangeably. The AN may include both a 3GPP radio access network and a non-3GPP access network. A typical non-3GPP access network is a Wi-Fi network.

As noted, under the current specification for PPD, it is unclear how to address all the requirements in the PFCP protocol, and doing so may lead to extraneous provisioning of PDRs, for example. Consider an example. When the requirement to set the PPI is not considered, for a SDF corresponding to application 1, the SMF may provision a PDR to identify the DL application traffic:
PDR1: Packet Detection Information (PDI) is set with App-ID=1, UE IP address, together with a
Forwarding Action Rule (FAR) FAR1 to forward traffic to the NG-RAN, and a QER for QoS;

Now consider the requirement that the SMF instruct the UPF to set PPI according to the DSCP code. For purposes of this example, the DSCP code to PPI mapping is configured per operator's paging policy, e.g., as shown below. Such mapping is needed here, since there are 64 DSCP code points while there are 8 PPI values, and such mapping may be configured per DNN/Single Network Slice Selection Assistance Identifier (S-NSSAI).
DSCP to PPI mapping:---at most 8 per index
   Paging Policy Indicator=1
   DSCP=EF
   DSCP=AF42
DSCP to PPI mapping:
   Paging Policy Indicator=2
   DSCP=AF11
   DSCP=AF12
   DSCP=AF13
And for any other DSCP codes, the PPI will be set to 3.
   With above DSCP(s) to PPI mapping, the SMF shall provision the following PDRs and QERs:
PDR1: PDI is set with App-ID=1 & DSCP EF & DSCP AF42, together with QER 1, set PPI=1;
PDR1: PDI is set with App-ID=1 & DSCP AF11 & DSCP AF12 & AF 13, together with QER 2, set PPI=2;
PDR1: PDI is set with App-ID=1, together with QER 3, set PPI=3;

So, for each SDF, the SMF needs to provision: (1) extra PDRs with the same application detection logic but different DSCP codes (which are mapped to different PPI); and (2) extra QERs with the same QoS requirement for different PPI.

In addition, since the PPI is only intended to be used by NG-RAN in case of NG-RAN paging, setting PPI for all DL packets would not be necessary and it will add extra processing load on the UPF.

Accordingly, embodiments provide for enhanced provisioning of PPI. For example, in embodiments:
1. Such DSCP to PPI mapping should be configured per PFCP session, as different DNN/S-NSSAI may have different paging policy, the SMF therefore can instruct the UPF if such DSCP to PPI mapping is needed; if it is needed, the SMF can provide a DSCP to PPI mapping table;
2. Since such DSCP to PPI mapping is only needed for NG-RAN paging when the UE is in the RRC inactive state, the SMF may provide a timer to the UPF, so that the UPF shall insert PPI for the first few DL packets after a time period when there is no UL and no DL payload during which it can be assumed that the UE may enter the RRC Inactive state.
3. Optionally add a list of QoS Flow Identifiers (QFIs), i.e. apply such DSCP to PPI mapping only for packets pertaining to the requested QoS flows.

For example, the SMF instructs the UPF to detect the DSCP in the ToS (IPv4)/TC (IPv6) value in the IP header of the DL PDU and transfer the corresponding PPI in the CN tunnel header. The instruction can be per PFCP session or 5QI or service. The UPF marks the PPI mapping from the DSCP of the incoming packet, and the DSCP to PPI mapping can be configured in UPF or can be instructed by the SMF. The SMF may instruct the UPF to only transfer the corresponding PPI in the first few downlink packets (for example the first 10 packets) after a period when there is no uplink and downlink payload during which it may be assumed that the UE enters the RRC_Inactive state.

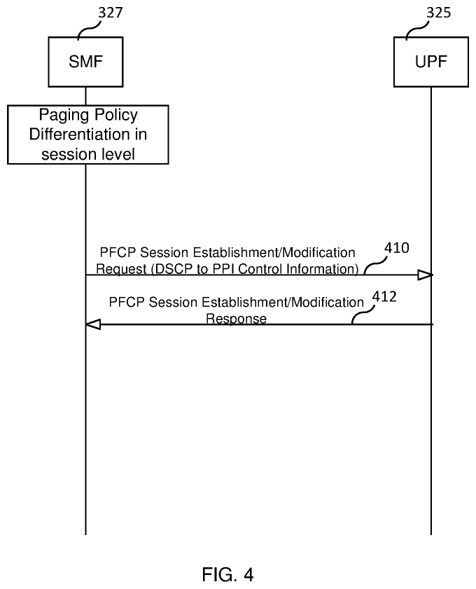

FIG. 4 illustrates a flow diagram according to an embodiment. As shown, the SMF enables Paging Policy per application for all service of the whole session or service of a Q. The SMF indicates to the UPF to enable PPD for all incoming packets. For example, in a PFCP Session Establishment (or Modification) Request 410, the SMF 327 may include DSCP to PPI Control Information. The UPF 325 may acknowledge this in the return PFCP Session Establishment (or Modification) Response 412.

Exemplary details of the information elements (IEs) are shown in tables 1-4 below.

TABLE 1
PFCP Session Establishment Request

| Information elements | | | | | | | |
|---|---|---|---|---|---|---|---|
| | | Appl. | | | | | |
| P | Condition/Comment | Sxa | Sxb | Sxc | N4 | N4mb | IE Type |

| | | | | |
|---|---|---|---|---|
| DSCP to PPI | C | This IE shall be present if the UPF is | X | DSCP to PPI |
| Control | | required to insert the PPI in the GTP-U | | Control |
| Information | | PDU Session Container extension header | | Information |
| | | of outgoing GTP-U packets based on the | | |
| | | DSCP in the ToS/TC field in the inner IP | | |
| | | header of incoming packets. | | |

TABLE 2
DSCP to PPI Control Information within PFCP Session Establishment Request

| | Octet 1 and 2 | | | | | | | |
|---|---|---|---|---|---|---|---|---|
| | | DSCP to PPI Control Information IE Type = aaa (decimal) | | | | | | |
| | Octets 3 and 4 | | | | | | | |
| | | Length = n | | | | | | |
| | Information elements | | | | | | | |
| | | | Appl. | | | | | |
| | P | Condition/Comment | Sxa | Sxb | Sxc | N4 | N4mb | IE Type |
| DSCP to PPI | C | This IE may be present to indicate the DSCP to | — | — | — | X | — | DSCP to PPI |
| Mapping | | PPI mapping table to instruct UPF to derive the | | | | | | Mapping |
| Information | | PPI information from the DSCP of the incoming | | | | | | Information |
| | | packets if the Paging Policy Indicator Mapping | | | | | | |
| | | information is instructed by SMF. | | | | | | |
| DSCP to PPI | C | This IE may be present to indicate the DSCP to | | | | X | | 0-7 |
| mapping | | PPI mapping table configured in UPF to instruct | | | | | | |
| index | | UPF to derive the PPI information from the DSCP | | | | | | |
| | | of the incoming packets if the Paging Policy | | | | | | |
| | | Indicator Mapping information is instructed by | | | | | | |
| | | SMF. | | | | | | |
| QFI | C | This IE shall be present to include a low layer | — | — | — | X | — | QFI |
| | | source specific multicast address information (i.e. | | | | | | |
| | | multicast destination address and related source | | | | | | |
| | | IP address) and a GTP-U Common Tunnel | | | | | | |
| | | EndPoint Identifier (C-TEID) which was allocated | | | | | | |
| | | by the UB-UPF, if IP multicast transport is used | | | | | | |
| | | over N19mb. | | | | | | |
| | | Several IEs with the same IE type may be | | | | | | |
| | | present to provision a list of QFIs. | | | | | | |
| No Payload | O | This IE may be present to instruct UPF to only | — | — | — | X | — | Inactivity |
| Duration | | insert the corresponding PPI in the first few | | | | | | Detection |
| | | downlink packets (e.g. the first 10 packets) after a | | | | | | Time |
| | | period when there is no UL and no DL payload. | | | | | | |

TABLE 3
DSCP to PPI Mapping Information

Bits

| | | | | | | | | |
|---|---|---|---|---|---|---|---|---|
| Octets | 8 | 7 | 6 | 5 | 4 | 3 | 2 | 1 |

| 1 to 2 | Type = bbb (decimal) | |
|---|---|---|
| 3 to 4 | Length = n | |
| 5 | Spare | PPI Value |

| | | |
|---|---|---|
| 6 | Spare | DSCP Value 1 |
| 7 | Spare | DSCP Value 2 |
| . . . | Spare | . . . |
| (5 + x) | Spare | DSCP Value x |

| | |
|---|---|
| (6 + x) | These octet(s) is/are present only if |
| to (n + 4) | explicitly specified |

The PPI Value in octet 5 shall be encoded as a value between 0 and 7 as specified in clause 5.5.3.7 of 3GPP TS 38.415.

TABLE 4
PFCP Session Modification Request

| Information elements | | | | | | | |
|---|---|---|---|---|---|---|---|
| | | Appl. | | | | | |
| P | Condition/Comment | Sxa | Sxb | Sxc | N4 | N4mb | IE Type |

| | | | | |
|---|---|---|---|---|
| DSCP to PPI | C | This IE shall be present if DSCP to PPI Control | X | DSCP to PPI |
| Control | | Information needs to be changed. | | Control |
| Information | | | | Information |

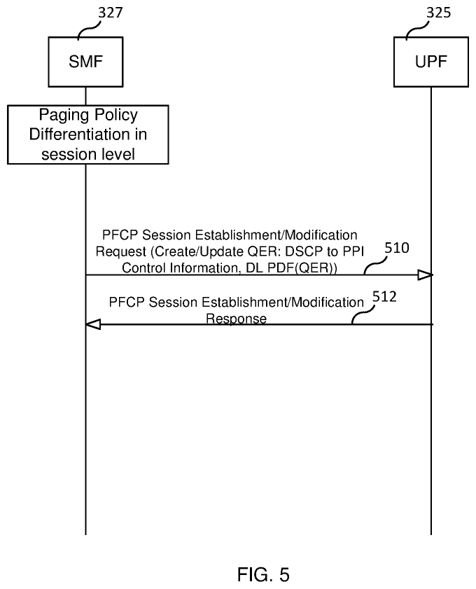

FIG. 5 illustrates a flow diagram according to an embodiment. As shown, the SMF enables Paging Policy per application. The SMF indicates to the UPF to enable PPD for all incoming packets. For example, in a PFCP Session Establishment (or Modification) Request 510, the SMF 327 may include DSCP to PPI Control Information (as shown in FIG. 4), and also Create/Update QER information. The UPF 325 may acknowledge this in the return PFCP Session Establishment (or Modification) Response 512.

Exemplary details of the information elements (IEs) are shown in tables 5-6 below.

TABLE 5
Create QER

| | | | | | | | |
|---|---|---|---|---|---|---|---|
| QER ID | M | This IE shall uniquely identify the QER among all the | — | X | X | X | QER ID |
| | | QER configured for that PFCP session | | | | | |
| DSCP to PPI | C | This IE shall be present if the UPF is required to insert | | | | | DSCP to PPI |
| Control | | the PPI in the GTP-U PDU Session Container extension | | | | | Control |
| Information | | header of outgoing GTP-U packets based on the DSCP | | | | | Information |
| | | in the ToS/Traffic Class field in the inner IP header of | | | | | |
| | | incoming packets. | | | | | |

TABLE 6
Update QER

| | | | | | | | |
|---|---|---|---|---|---|---|---|
| QER ID | M | This IE shall uniquely identify the QER among all the | — | X | X | X | QER ID |
| | | QER configured for that PFCP session | | | | | |
| DSCP to PPI | C | This IE shall be present if it needs to be modified. | | | | | DSCP to PPI |
| Control | | | | | | | Control |
| Information | | | | | | | Information |

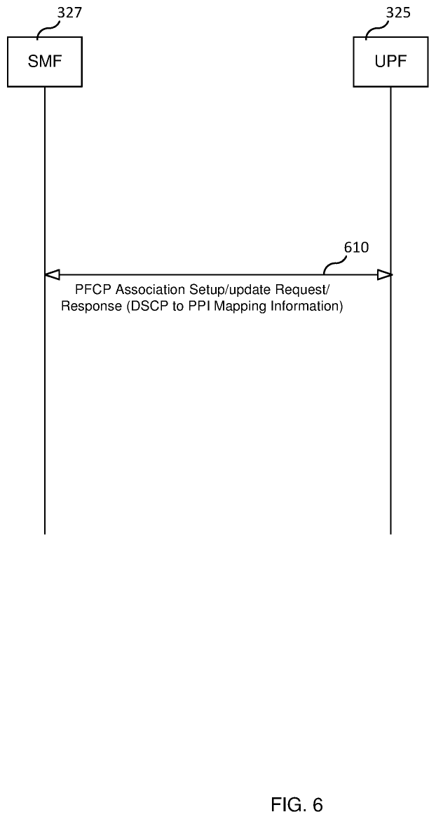

FIG. 6 illustrates a flow diagram according to an embodiment. As shown, the DSCP to PPI mapping information can be configured in the UPF or can be instructed by the SMF in node level, if it provisioned from the SMF. For example, in a PFCP Session Establishment (or Modification) Request or Response 610, the SMF 327 may include DSCP to PPI Mapping Information.

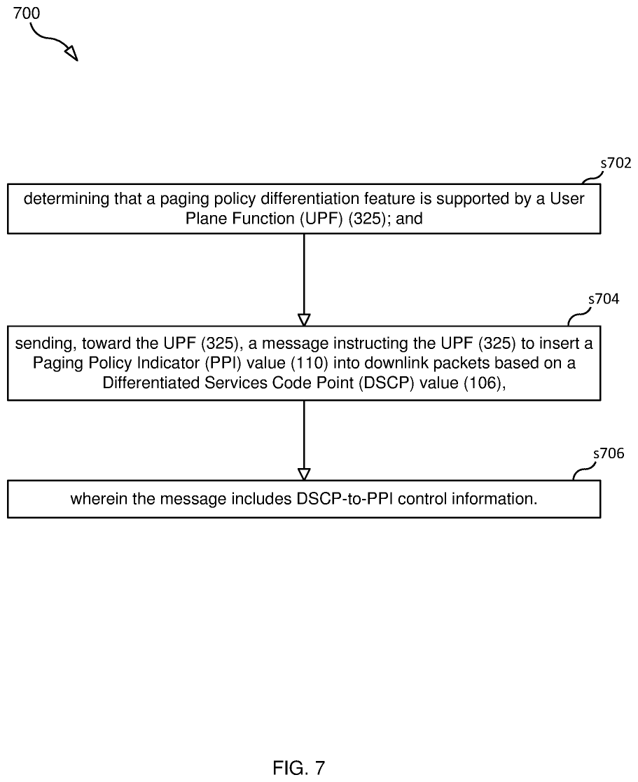

FIG. 7 illustrates a flowchart illustrating a process 700 according to some embodiments. Process 700 may begin with step s702, and is a method for facilitating paging policy differentiation, performed by a Session Management Function (SMF), such as SMF 327.

Step s702 comprises determining that a paging policy differentiation feature is supported by a User Plane Function (UPF) (325) and that the paging policy differentiation feature is applicable to a Protocol Data Unit (PDU) Session.

Step s704 comprises sending, toward the UPF (325), a message instructing the UPF (325) to insert a Paging Policy Indicator (PPI) value (110) into outgoing packets based on a Differentiated Services Code Point (DSCP) value (106).

Step s706 comprises wherein the message includes DSCP-to-PPI control information.

In some embodiments, the message instructs the UPF (325) to insert the PPI value into a General Packet Radio System (GPRS) Tunneling Protocol User Plane (GTP-U) layer extension header of GTP-U packets encapsulating payload packets and the DSCP value is in the IP header of the payload packets. In some embodiments, the DSCP-to-PPI control information further includes one or more DSCP-to-PPI mapping information, one or more Quality of Service (QoS) flow identifiers (QFIs), and a timer. In some embodiments, the timer is configured to cause the UPF to insert corresponding PPI values into a fixed number of outgoing packets only after a period determined by the timer when there is no incoming or outgoing packets.

In some embodiments, the one or more QFIs indicate to the UPF to which Qos Flows payload packets pertain that are eligible for inserting PPI based on the DSCP-to-PPI mapping information. In some embodiments, the DSCP-to-PPI mapping information includes one of (1) an index to enable the UPF to select a DSCP-to-PPI mapping table preconfigured in the UPF, and (2) a table mapping the DSCP of payload packets to a corresponding PPI. In some embodiments, the message is a Packet Forwarding Control Protocol (PFCP) session message. In some embodiments, the PFCP message is one of a PFCP Session Establishment Request or a PFCP Session Modification Request.

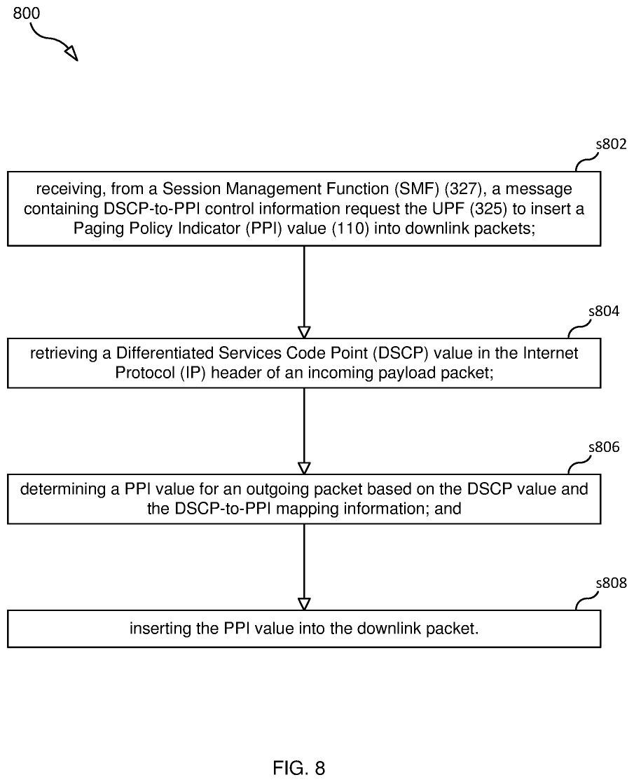

FIG. 8 illustrates a flowchart illustrating a process 800 according to some embodiments. Process 800 may begin with step s802, and is a method for facilitating paging policy differentiation, performed by a User Plane Function (UPF), such as UPF 325.

Step s802 comprises receiving, from a Session Management Function (SMF) (327), a message containing DSCP-to-PPI control information request the UPF (325) to insert a Paging Policy Indicator (PPI) value (110) into outgoing packets.

Step s804 comprises retrieving a Differentiated Services Code Point (DSCP) value in the Internet Protocol (IP) header of an incoming payload packet.

Step s806 comprises determining a PPI value for an outgoing packet based on the DSCP value and the DSCP-to-PPI mapping information.

Step s808 comprises inserting the PPI value into the outgoing packet.

In some embodiments, the message requests the UPF (325) to insert the PPI value into a General Packet Radio System (GPRS) Tunneling Protocol User Plane (GTP-U) layer extension header of outgoing GTP-U packets encapsulating payload packets. In some embodiments, the DSCP-to-PPI control information further includes one or more DSCP-to-PPI mapping information, one or more Quality of Service (QoS) flow identifiers (QFIs), and a timer. In some embodiments, the timer is configured to cause the UPF to insert corresponding PPI values into a fixed number of outgoing packets only after a period determined by the timer when there is no incoming or outgoing packets, and further comprising: determining that there has been no incoming or outgoing packets for a time period based on the timer; and as a result of determining that there has been no incoming or outgoing packets for a time period based on the timer, inserting the PPI value into the fixed number of outgoing packets.

In some embodiments, the one or more QFIs indicate to the UPF to which Qos Flows payload packets pertain that are eligible for inserting PPI based on the DSCP-to-PPI mapping information; and further comprising, prior to inserting the PPI value into the outgoing packet, determining that the outgoing packet matches a QFI of the one or more QFIs. In some embodiments, the DSCP-to-PPI mapping information includes one of (1) an index to enable the UPF to select a DSCP-to-PPI mapping table preconfigured in the UPF, and (2) a table mapping the DSCP of payload packets to a corresponding PPI. In some embodiments, the message is a Packet Forwarding Control Protocol (PFCP) session message. In some embodiments, the PFCP session message is one of a PFCP Session Establishment Request or a PFCP Session Modification Request.

### Summary of Various Embodiments

A1. A method for facilitating paging policy differentiation, performed by a Session Management Function (SMF) (327), the method comprising:
determining that a paging policy differentiation feature is supported by a User Plane Function (UPF) (325) and that the paging policy differentiation feature is applicable to a Protocol Data Unit (PDU) Session; and
sending, toward the UPF (325), a message instructing the UPF (325) to insert a Paging Policy Indicator (PPI) value (110) into outgoing packets based on a Differentiated Services Code Point (DSCP) value (106),
wherein the message includes DSCP-to-PPI control information.

A2. The method of embodiment A1, wherein the message instructs the UPF (325) to insert the PPI value into a General Packet Radio System (GPRS) Tunneling Protocol User Plane (GTP-U) layer extension header of GTP-U packets encapsulating payload packets and the DSCP value is in the IP header of the payload packets.

A3. The method of any one of embodiments A1-A2, wherein the DSCP-to-PPI control information further includes one or more DSCP-to-PPI mapping information, one or more Quality of Service (QoS) flow identifiers (QFIs), and a timer.

A4. The method of embodiment A3, wherein the timer is configured to cause the UPF to insert corresponding PPI values into a fixed number of outgoing packets only after a period determined by the timer when there is no incoming or outgoing packets.

A5. The method of any one of embodiments A2-A4, wherein the one or more QFIs indicate to the UPF to which Qos Flows payload packets pertain that are eligible for inserting PPI based on the DSCP-to-PPI mapping information.

A6. The method of any one of embodiments A2-A5, wherein the DSCP-to-PPI mapping information includes one of (1) an index to enable the UPF to select a DSCP-to-PPI mapping table preconfigured in the UPF, and (2) a table mapping the DSCP of payload packets to a corresponding PPI.

A7. The method of any one of embodiments A1-A6, wherein the message is a Packet Forwarding Control Protocol (PFCP) session message.

A8. The method of embodiment A7, wherein the PFCP message is one of a PFCP Session Establishment Request or a PFCP Session Modification Request.

B1. A method for facilitating paging policy differentiation, performed by a User Plane Function (UPF) (325), the method comprising:
receiving, from a Session Management Function (SMF) (327), a message containing DSCP-to-PPI control information request the UPF (325) to insert a Paging Policy Indicator (PPI) value (110) into outgoing packets;
retrieving a Differentiated Services Code Point (DSCP) value in the Internet Protocol (IP) header of an incoming payload packet;
determining a PPI value for an outgoing packet based on the DSCP value and the DSCP-to-PPI mapping information; and
inserting the PPI value into the outgoing packet.

B2. The method of embodiment B1, wherein the message requests the UPF (325) to insert the PPI value into a General Packet Radio System (GPRS) Tunneling Protocol User Plane (GTP-U) layer extension header of outgoing GTP-U packets encapsulating payload packets.

B3. The method of any one of embodiments B1-B2, wherein the DSCP-to-PPI control information further includes one or more DSCP-to-PPI mapping information, one or more Quality of Service (QoS) flow identifiers (QFIs), and a timer.

B4. The method of embodiment B3, wherein the timer is configured to cause the UPF to insert corresponding PPI values into a fixed number of outgoing packets only after a period determined by the timer when there is no incoming or outgoing packets, and further comprising:
determining that there has been no incoming or outgoing packets for a time period based on the timer; and
as a result of determining that there has been no incoming or outgoing packets for a time period based on the timer, inserting the PPI value into the fixed number of outgoing packets.

B5. The method of any one of embodiments B3-B4, wherein the one or more QFIs indicate to the UPF to which Qos Flows payload packets pertain that are eligible for inserting PPI based on the DSCP-to-PPI mapping information; and further comprising, prior to inserting the PPI value into the outgoing packet, determining that the outgoing packet matches a QFI of the one or more QFIs.

B6. The method of any one of embodiments B3-B5, wherein the DSCP-to-PPI mapping information includes one of (1) an index to enable the UPF to select a DSCP-to-PPI mapping table preconfigured in the UPF, and (2) a table mapping the DSCP of payload packets to a corresponding PPI.

B7. The method of any one of embodiments B1-B6, wherein the message is a Packet Forwarding Control Protocol (PFCP) session message.

B8. The method of embodiment B7, wherein the PFCP session message is one of a PFCP Session Establishment Request or a PFCP Session Modification Request.

C1. A computer program (943) comprising instructions (944) which when executed by processing circuitry (902) causes the processing circuitry (902) to perform the method of any one embodiments A1-A8 and B1-B8.

C2. A carrier containing the computer program of claim 17, wherein the carrier is one of an electronic signal, an optical signal, a radio signal, and a computer readable storage medium (942).

D1. An apparatus (900), the apparatus being configured to perform the method of any one the above embodiments A1-A8 and B1-B8.

E1. A Session Management Function (SMF) (327) node, the node being configured to:
determine that a paging policy differentiation feature is supported by a User Plane Function (UPF) (325) and that the paging policy differentiation feature is applicable to a Protocol Data Unit (PDU) Session; and
send, toward the UPF (325), a message instructing the UPF (325) to insert a Paging Policy Indicator (PPI) value (110) into outgoing packets based on a Differentiated Services Code Point (DSCP) value (106),
wherein the message includes DSCP-to-PPI control information.

E2. The node of embodiment E1, wherein the message instructs the UPF (325) to insert the PPI value into a General Packet Radio System (GPRS) Tunneling Protocol User Plane (GTP-U) layer extension header of GTP-U packets encapsulating payload packets and the DSCP value is in the IP header of the payload packets.

E3. The node of any one of embodiments E1-E2, wherein the DSCP-to-PPI control information further includes one or more DSCP-to-PPI mapping information, one or more Quality of Service (QoS) flow identifiers (QFIs), and a timer.

E4. The node of any one of embodiment E3, wherein the timer is configured to cause the UPF to insert corresponding PPI values into a fixed number of outgoing packets only after a period determined by the timer when there is no incoming or outgoing packets.

E5. The node of any one of embodiments E3-E4, wherein the one or more QFIs indicate to the UPF to which Qos Flows payload packets pertain that are eligible for inserting PPI based on the DSCP-to-PPI mapping information.

E6. The node of any one of embodiments E3-E5, wherein the DSCP-to-PPI mapping information includes one of (1) an index to enable the UPF to select a DSCP-to-PPI mapping table preconfigured in the UPF, and (2) a table mapping the DSCP of payload packets to a corresponding PPI.

E7. The node of any one of embodiments E1-E6, wherein the message is a Packet Forwarding Control Protocol (PFCP) session message.

E8. The node of embodiment E7, wherein the PFCP message is one of a PFCP Session Establishment Request or a PFCP Session Modification Request.

F1. A User Plane Function (UPF) (325) node, the node being configured to:
receive, from a Session Management Function (SMF) (327), a message containing DSCP-to-PPI control information request the UPF (325) to insert a Paging Policy Indicator (PPI) value (110) into outgoing packets;
retrieve a Differentiated Services Code Point (DSCP) value in the Internet Protocol (IP) header of an incoming payload packet;
determine a PPI value for an outgoing packet based on the DSCP value and the DSCP-to-PPI mapping information; and
insert the PPI value into the outgoing packet.

F2. The node of embodiment F1, wherein the message requests the UPF (325) to insert the PPI value into a General Packet Radio System (GPRS) Tunneling Protocol User Plane (GTP-U) layer extension header of outgoing GTP-U packets encapsulating payload packets.

F3. The node of any one of embodiments F1-F2, wherein the DSCP-to-PPI control information further includes one or more DSCP-to-PPI mapping information, one or more Quality of Service (QoS) flow identifiers (QFIs), and a timer.

F4. The node of embodiment F3, wherein the timer is configured to cause the UPF to insert corresponding PPI values into a fixed number of outgoing packets only after a period determined by the timer when there is no incoming or outgoing packets, and the node is further configured to:
determine that there has been no incoming or outgoing packets for a time period based on the timer; and
as a result of determining that there has been no incoming or outgoing packets for a time period based on the timer, insert the PPI value into the fixed number of outgoing packets.

F5. The node of any one of embodiments F3-F4, wherein the one or more QFIs indicate to the UPF to which Qos Flows payload packets pertain that are eligible for inserting PPI based on the DSCP-to-PPI mapping information; and the node is further configured to, prior to inserting the PPI value into the outgoing packet, determine that the outgoing packet matches a QFI of the one or more QFIs.

F6. The node of any one of embodiments F3-F5, wherein the DSCP-to-PPI mapping information includes one of (1) an index to enable the UPF to select a DSCP-to-PPI mapping table preconfigured in the UPF, and (2) a table mapping the DSCP of payload packets to a corresponding PPI.

F7. The node of any one of embodiments F1-F6, wherein the message is a Packet Forwarding Control Protocol (PFCP) session message.

F8. The node of embodiment F7, wherein the PFCP session message is one of a PFCP Session Establishment Request or a PFCP Session Modification Request.

G1. An apparatus (900), the apparatus being configured to perform the method of any one the above embodiments A1-A8 and B1-B8.

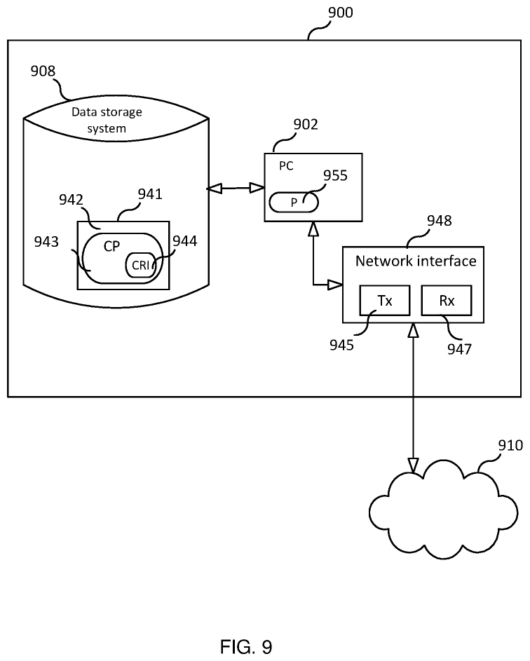

FIG. 9 is a block diagram of a physical machine (or “apparatus”) 900, according to some embodiments, which can be used to run any one of UPF 325 and SMF 327. As shown in FIG. 9, apparatus 900 may comprise: processing circuitry (PC) 902, which may include one or more processors (P) 955 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 900 may be a distributed computing apparatus); a network interface 948 comprising a transmitter (Tx) 945 and a receiver (Rx) 947 for enabling apparatus 900 to transmit data to and receive data from other machines connected to a network 910 (e.g., an Internet Protocol (IP) network) to which network interface 948 is connected (directly or indirectly) (e.g., network interface 948 may be wirelessly connected to the network 110, in which case network interface 948 is connected to an antenna arrangement); and a local storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes apparatus 900 to perform steps described herein (e.g., steps described herein with reference to the flow charts). In other embodiments, apparatus 900 may be configured to perform steps described herein without the need for code. That is, for example, PC 902 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for facilitating paging policy differentiation, performed by a session management function (SMF), the method comprising:
determining that a paging policy differentiation feature is supported by a user plane function (UPF); and
sending, toward the UPF, a message instructing the UPF to insert a paging policy indicator (PPI) value into downlink packets based on a differentiated services code point (DSCP) value, wherein
the message includes DSCP-to-PPI control information.

2. The method of claim 1, wherein the message instructs the UPF to insert the PPI value into a General Packet Radio System (GPRS) Tunneling Protocol User Plane (GTP-U) layer extension header of GTP-U packets encapsulating payload packets.

3. The method of claim 1, wherein the DSCP-to-PPI control information further includes one or more DSCP-to-PPI mapping information and/or one or more quality-of-service (QoS) flow identifiers (QFIs).

4. The method of claim 1, further comprising, prior to sending, toward the UPF, a message instructing the UPF to insert a PPI value into downlink packets based on DSCP value, determining that the paging policy differentiation feature is applicable to a Protocol Data Unit (PDU) Session.

5. The method of claim 2, wherein the one or more QFIs indicate to the UPF to which Qos Flows payload packets pertain that are eligible for inserting PPI based on the DSCP-to-PPI mapping information.

6. The method of claim 2, wherein the DSCP-to-PPI mapping information includes a table mapping the DSCP of payload packets to a corresponding PPI, the table including one or more DSCP identifiers corresponding to a PPI identifier.

7. The method of claim 1, wherein the message is a Packet Forwarding Control Protocol (PFCP) session message.

8. The method of claim 7, wherein the PFCP message is a PFCP Session Establishment Request or a PFCP Session Modification Request.

9. A method for facilitating paging policy differentiation, performed by a user plane function (UPF), the method comprising:
receiving, from a session management function (SMF), a message containing DSCP-to-PPI control information request the UPF to insert a paging policy indicator (PPI) value into downlink packets;
retrieving a differentiated services code point (DSCP) value in the Internet Protocol (IP) header of an incoming payload packet;
determining a PPI value for a downlink packet based on the DSCP value and the DSCP-to-PPI mapping information; and
inserting the PPI value into the downlink packet.

10-16. (canceled)

17. A non-transitory computer readable storing medium storing a computer program comprising instructions which when executed by processing circuitry causes the processing circuitry to perform the method of claim 1.

18. (canceled)

19. (canceled)

20. A session management function (SMF) node, the node being configured to:
determine that a paging policy differentiation feature is supported by a user plane function (UPF); and
send, toward the UPF, a message instructing the UPF to insert a paging policy indicator (PPI) value into downlink packets based on a differentiated services code point (DSCP) value,
wherein the message includes DSCP-to-PPI control information.

21. The node of claim 20, wherein the message instructs the UPF to insert the PPI value into a General Packet Radio System (GPRS) Tunneling Protocol User Plane (GTP-U) layer extension header of GTP-U packets encapsulating payload packets.

22. The node of claim 20, wherein the DSCP-to-PPI control information further includes one or more DSCP-to-PPI mapping information and/or one or more Quality of Service (QoS) flow identifiers (QFIs).

23. The node of claim 20, being further configured to, prior to sending, toward the UPF, a message instructing the UPF to insert a paging policy indicator (PPI) value into downlink packets based on a differentiated services code point (DSCP) value, determine that the paging policy differentiation feature is applicable to a Protocol Data Unit (PDU) Session.

24. The node of claim 21, wherein the one or more QFIs indicate to the UPF to which Qos Flows payload packets pertain that are eligible for inserting PPI based on the DSCP-to-PPI mapping information.

25. The node of claim 21, wherein the DSCP-to-PPI mapping information includes a table mapping the DSCP of payload packets to a corresponding PPI, the table including one or more DSCP identifiers corresponding to a PPI identifier.

26. The node of claim 20, wherein the message is a Packet Forwarding Control Protocol (PFCP) session message.

27. The node of claim 26, wherein the PFCP message is a PFCP Session Establishment Request or a PFCP Session Modification Request.

28. A user plane function (UPF) node, the node being configured to:
receive, from a session management function (SMF), a message containing DSCP-to-PPI control information request the UPF to insert a paging policy indicator (PPI) value into downlink packets;
retrieve a differentiated services code point (DSCP) value in the Internet Protocol (IP) header of an incoming payload packet;
determine a PPI value for a downlink packet based on the DSCP value and the DSCP-to-PPI mapping information; and
insert the PPI value into the downlink packet.

29. The node of claim 28, wherein the message requests the UPF to insert the PPI value into a General Packet Radio System (GPRS) Tunneling Protocol User Plane (GTP-U) layer extension header of downlink GTP-U packets encapsulating payload packets.

30. The node of claim 28, wherein the DSCP-to-PPI control information further includes one or more DSCP-to-PPI mapping information and/or one or more Quality of Service (QoS) flow identifiers (QFIs).

31. (canceled)

32. The node of claim 30, wherein the one or more QFIs indicate to the UPF to which Qos Flows payload packets pertain that are eligible for inserting PPI based on the DSCP-to-PPI mapping information; and the node is further configured to, prior to inserting the PPI value into the downlink packet, determine that the downlink packet matches a QFI of the one or more QFIs.

33. The node of claim 30, wherein the DSCP-to-PPI mapping information includes a table mapping the DSCP of payload packets to a corresponding PPI, the table including one or more DSCP identifiers corresponding to a PPI identifier.

34. The node of claim 28, wherein the message is a Packet Forwarding Control Protocol (PFCP) session message.

35. The node of claim 34, wherein the PFCP session message is a PFCP Session Establishment Request or a PFCP Session Modification Request.
